(19) United States
(12) Patent Application Publication
(10) Pub. No.: US 2008/0259510 A1
(43) Pub. Date: Oct. 23, 2008

(54) Control Apparatus for an Actuating Device in a Motor Vehicle

(76) Inventors: Markus Schussler, Zeitlofs (DE); Thomas Rosch, Querfurt (DE)

Correspondence Address: WHITE & CASE LLP;PATENT DEPARTMENT, 1155 AVENUE OF THE AMERICAS, NEW YORK, NY, 10036, US

(21) Appl. No.: 11/571,123

(22) PCT Filed: Jun. 24, 2005
(86) PCT No.: PCT/EP2005/006849

§ 371 Date: Jan. 14, 2008

(30) Foreign Application Priority Data
Jun. 24, 2004 (DE) 20 2002 009 921.7

(51) Int. Cl. H02H 7/085

(52) U.S. Cl. 361/23

(57) ABSTRACT

Control apparatus for an actuating device in a motor vehicle, in particular a motor vehicle seat actuating device, having a sensor for determination of an actual speed of a drive movement of a drive for the actuating device, having a computation unit which is connected to the sensor, and having a power driver for passing current through the drive as a function of the control signal, with the computation unit being designed and configured to regulate the actuating speed of the drive movement as a function of the actual speed and of a predeterminable set speed by means of a control signal, and to stop or to reverse the drive movement as a function of an evaluation, associated with trapping, of the control signal.

The invention relates to a control apparatus for controlling an actuating device in a motor vehicle.

The invention is based on the object of specifying a particularly suitable method and a particularly suitable control apparatus for controlling an actuating device in a motor vehicle. The particular aim in this case is to achieve a high level of safety for a user of the actuating device in the motor vehicle.

With reference to the method, the stated object is achieved according to the invention by the features of Claims 1 and 15. Advantageous developments are the subject matter of the dependent claims which refer back to them.

With regard to the apparatus, the stated object is achieved according to the invention by the features of Claim 16. Expedient refinements are the subject matter of the dependent claims which refer back to it.

A control apparatus is accordingly provided for controlling an actuating device in a motor vehicle, which control apparatus is particularly suitable for controlling a motor vehicle seat actuating device. The control apparatus has a sensor for determination of an actual variable of a drive movement of a drive for the actuating device. An actual variable such as this is preferably an actual speed. It is also possible for the actual variable to be an actual position, an actual acceleration or a rate of change of the actual acceleration, or which additionally has that. For example, a Hall sensor is used for this purpose and interacts with a magnetic transmitter which rotates with the drive. A further example of a sensor for determination of an actual speed or of some other actual variable is a current sensor, which allows detection of the ripple on the drive current. The time intervals between the waves of the ripple are in this case dependent on the rotation angle and/or on the rotation speed, which in this case corresponds to the actual speed.

The sensor is connected to a computation unit. This computation unit is, for example, an analog computation unit, hard-wired logic, an application-specific circuit (ASIC) which is equipped with a hard-wired program or, preferably, a programmable computation unit, for example a microcontroller. This computation unit is designed and configured to regulate the actuating movement, preferably the actuating speed of the drive movement, as a function of the actual variable and of a predeterminable set variable by means of a control signal. Furthermore, analogously to the actual variable, it is possible for the set variable to be a set position, a set acceleration or a rate of change of the set acceleration, or additionally to have that.

Furthermore, the computation unit is designed and configured to stop or to reverse the drive movement as a function of an evaluation of the control signal associated with trapping. In addition, a power driver is provided in order to pass current through the drive as a function of the control signal.

The invention also covers a method which, for example, runs as a program within the computation unit. In this method, a drive movement of a drive for the actuating device is stopped and/or the drive movement is reversed when trapping of an object or of a body part is determined. The actuating movement is in this case regulated by predetermining a set variable, preferably a set speed, determining an actual variable, preferably the actual speed of the drive for the actuating device, and by controlling the power supplied to the drive as a function of the set variable and the actual variable, by means of a control signal. According to the invention, the control signal is evaluated in order to determine trapping.

Advantageous refinement variants of the invention which relate to possible evaluation of the control signal will be described in the following text. These evaluations can also be combined with one another. Two refinement variants provide for the control signal or the rate of change of the control signal to be compared with a threshold value by means of the computation unit. The computation unit is designed to compare the threshold value which, for example, is temporarily stored in a register, with preferably successive control signal values or rates of change of the control signal values. Rates of change such as these are, for example, values of the first or second derivative of the control signal values with respect to time. The control signal values are, for example, discrete-time values for this purpose. If, in contrast, an analog computation unit is used, then continuous-time control signal values can also be compared. Furthermore, the control signal values and the values of the rates of change of the control signal can also be evaluated in a combined form, by using an algorithm or a gate to logically link two threshold-value overshoots or undershoots.

In order to take account of characteristics of the actuating movement, the threshold value for positions within the actuating movement is, according to one advantageous development, determined by evaluation of the control signal or of the rate of change of the control signal as a function of the actuating position. This value is stored in a memory, preferably in a non-volatile memory. For this purpose, by way of example, the computation unit may have a microcontroller with an EPROM. The threshold value in this development is dependent on the actuating movement, so that different values for the threshold value are stored for different positions and in particular with respect to the associated actuating direction. This threshold-value profile is dependent on the control signal value associated with the respective actuating position. Difficult movements and easy movements of the mechanical parts of the actuating system are mapped onto the control value profile, which is dependent on the actuating position. The values of the threshold-value profile are preferably updated during the actuating movement. By way of example, the updating process is carried out by averaging of the values of a plurality of actuating movements.

One particularly preferred development provides for the control signal to be transformed for evaluation, and for the control signal, which has preferably been transformed to the frequency domain, to be evaluated in the computation unit in order to determine trapping. This development is advantageously used in conjunction with the already described evaluation of the characteristics of the actuating movement, by evaluating the transformed signal as a function of the actuating position, with respect to the characteristics which are dependent on the actuating movement. One transformation that may be used is advantageously Fourier transformation or, particularly preferably, a wavelet transformation.

One preferred refinement provides for use of the difference between a natural frequency or a plurality of natural frequencies of the closed-loop control system from characteristic frequencies of trapping. The natural frequency is in this case preferably defined by the computation unit, so that the signal for the natural frequency and those components of the control signal which relate to trapping can be evaluated differently. The regulator and the detection of trapping are thus preferably matched to one another.

In this case, provision is made for the set speed to be predetermined, in particular as a function of the actuating position and/or as a function of the actuating time, in such a manner that a characteristic of trapping is amplified in comparison to a characteristic for a different set speed. In this case, known difficulties of movement or other known mechanical constraints can also be included in the presetting of the set speed, in order to optimize the signal-to-noise ratio for the evaluation of the control signal.

A measurement and an evaluation of the motor current are possible in order to determine trapping. In this case, the motor current is dependent on the actuating torque that is applied. If the drive is being regulated, the power supplied to the motor is a function of the control variable, which is converted to a pulse-width-modulated signal. This pulse-width-modulated signal controls a power driver, for example a MOSFET transistor or a DMOS transistor, which allows current to be passed through the drive as a function of this pulse-width-modulated signal. At least one mechanically or electrically dependent system response is taken into account in order to measure the current flowing through the motor.

One particularly advantageous development provides for other measurement variables of the actuating device to be evaluated combined with the control signal, in addition to the evaluation of the control signal, in order to determine trapping. This measurement variable is preferably the previously mentioned absolute magnitude or direct-current component of the motor current. Alternatively, further environmental conditions relating to the actuating device can also be measured, for example the temperature of the actuating device or the voltage of the voltage supply, that is to say in particular of the battery in the motor vehicle. One or more control variables can advantageously be evaluated as an alternative to or else in combination with these measurement variables. By way of example, one important control variable is the instantaneous duty ratio of a pulse-width-modulated signal for driving a power driver stage, which is used to pass current through the drive.

As a development of the invention, the computation unit is designed and configured in such a manner that the set speed is predetermined as a function of the actuating position and/or as a function of the actuating time, in order to increase the detection sensitivity for trapping within specific areas of the actuating movement. The set speed is preferably predetermined in such a manner that frequency bands of the control signal which are characteristic of trapping can be detected with as little interference as possible. In particular, a high set speed results in a fuzzy frequency spectrum, whose fuzziness decreases as the set speed decreases. In addition, at relatively low set speeds, there is comparatively little kinetic energy in the mechanical system of the actuating device, so that more time is available for the computation unit to react to detected events. The set speed is preferably reduced in predetermined areas of the actuating movement. These actuating areas have, for example, an increased risk of trapping for a motor vehicle occupant.

The set speed is preferably reduced as a function of the evaluation (which is dependent on the actuating position) of the control signal or of the rate of change of the control signal. This makes it possible to also take account of difficulties of movement in the system or of known forces which the user applies to the system, and these are included in the evaluation of the control signal, as a disturbance variable.

One advantageous refinement provides for a sensor signal which is dependent on the actual speed to be sampled in order to determine the actual speed. By way of example, a microcontroller interrupt can be used for sampling purposes. The sampling is for this purpose preferably greater than the signal change of the sensor.

In combination with or as an alternative to the sampling of the sensor signal, the actual speed is determined from a motor model, according to one advantageous development. This motor model makes it possible to determine the actuating position and the actuating speed as a function of electromechanical parameters which are contained in the motor model. One motor characteristic variable is used as an input variable for the motor model. This is preferably the motor current, which is determined or detected by means of a current sensor. In this case, both the direct-current component and any commutation-dependent ripple on the motor current are advantageously evaluated from the motor current, as an input variable for the motor model.

According to one further advantageous development, the determination of the rotation speed and/or of the rotation angle in the case of mechanically commutated direct-current motors from the time profile of the motor-current ripple which occurs during commutation is supplemented and monitored by a motor state model which operates in parallel with this, on which the electromechanical motor equations are based. The motor current and the motor voltage are used to extrapolate a probable value of the instantaneous rotation speed, and preferably to determine a permissible set value range for the next commutation. If it is not possible to define a commutation time in the set value range, then the extrapolated value is advantageously used. Otherwise, the instantaneous rotation speed is determined accurately from the commutation time detected by measurement of the ripple in the set value range. The motor-specific and load-dependent variable which is required for the motor state model can be predetermined as fixed or can in each case be matched to the instantaneous rotation speed, and learnt, after detection of commutation processes. This makes it possible to avoid disturbances in the detection and evaluation of the motor-current ripple which occurs during commutation. Furthermore, this can ensure that the instantaneous values are passed on without any interference, as is necessary for position determination and control of electrically operated parts.

It is thus possible to determine the motor impedance right at the starting time, even before overcoming the static friction, since in this case the rotation speed is still zero and there cannot yet be any induced armature voltage. The value of the motor impedance can be matched adaptively by multiple detection of the motor current and motor voltage, so that it is largely possible to preclude errors. In addition, a temperature-dependent and load-dependent motor-specific variable for the motor equation can be determined again after each commutation process, so that the influence of the temperature and load on the motor equation can be taken into account for the subsequent extrapolation. If the operating time of the motor will be relatively short, then the motor-specific variable may also remain unchanged throughout the entire operating time at the fixed predetermined value, since, in particular, the thermal influence acts very much more slowly and weakly in comparison to this.

Furthermore, provision is preferably made for the control signal to be converted to a motor control variable for power control, in order to regulate the actuating speed. The motor control variable is, for example, a motor voltage, a frequency which is used in particular to drive a synchronous motor, or a motor current. However, the motor control variable is particularly preferably a ratio of a pulse-width-modulated signal, which results in a mean motor voltage.

One further development provides for the actual speed to be determined as a function of the motor control variable, in particular as a function of the pulse-width modulation. If, for example, the motor current, in particular any ripple on the motor current, is sensed in order to determine the actual speed, then, in order to evaluate the motor current, its pulsed response with respect to the pulse-width modulation is also taken into account.

Various holding types of drive may be chosen in order to stop the drive. In addition to stopping by means of a mechanical element, the electric motor can also be short-circuited or switched such that no current is flowing or no voltage is applied, by means of additional switches. The drive is preferably stopped by setting the set speed to the value zero. This is advantageously combined with further control steps, by passing current through the drive in an opposite direction in order to reverse the drive movement, and by setting the set speed, at least temporarily, to a maximum value.

A further aspect relates to the already mentioned safety concept in conjunction with regulation of the actuating torque of the drive. Any drive movement of a drive for the actuating device is accordingly stopped, and/or the drive movement is reversed, when trapping of an object or of a body part is determined. In this case, the actuating torque is regulated by predetermining a set torque and by determining the actual torque of the drive for the actuating device, and by controlling the power supplied to the drive as a function of the set torque and the actual torque, by means of a control signal. Furthermore, the control signal is evaluated in order to determine trapping. This concept can advantageously be combined analogously with the already described developments and refinements for actuating speed regulation according to the invention. Furthermore, it is also advantageous to provide both torque regulation and speed regulation, at least in each case in sections of the actuating movement.

Exemplary embodiments of the invention will be explained in more detail in the following text with reference to a drawing, in which:

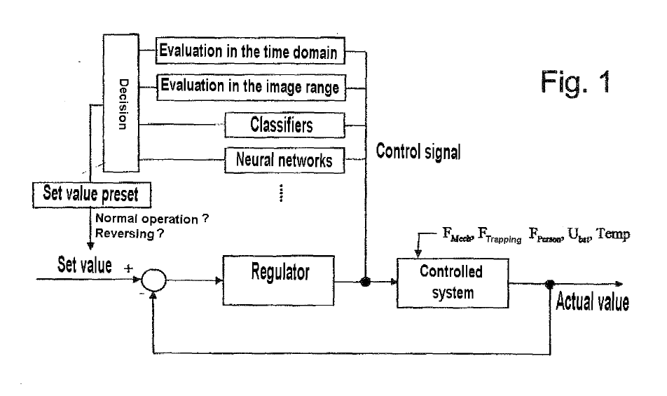

FIG. 1 shows a schematic illustration of a regulator model with trapping protection detection, and

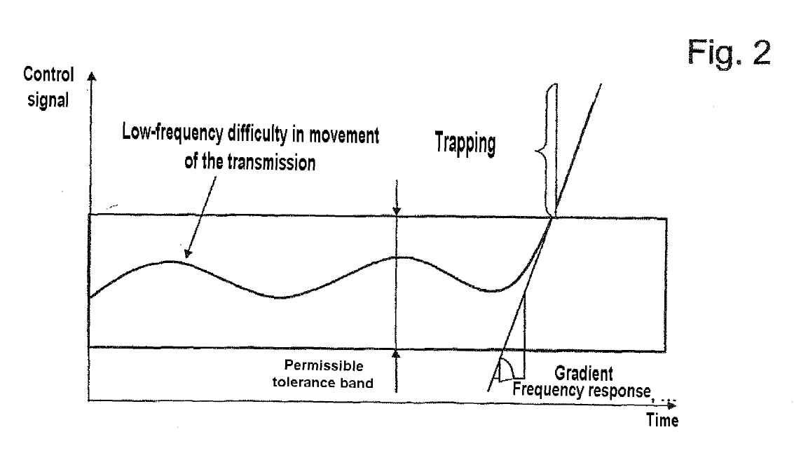

FIG. 2 shows a schematic illustration of a time profile of the control signal.

The regulator model in FIG. 1 has a set value as the input value and an actual value as the output value. In this case, by way of example, the set value is a set speed or a set torque. The actual value is then an actual speed or an actual torque, respectively. The actual value is in this case preferably detected by means of a sensor, for example a speed sensor or current sensor. By way of example, a Hall sensor, which interacts with a magnet that moves with the drive movement as a transmitter, is suitable for use as a speed sensor. The discrepancy between the set value and the actual value is supplied to a regulator. A PI or PID regulator is preferably suitable for use as the regulator.

The controlled system is described by the electromechanical system response of the actuating device, which is dependent on the actuating position and/or is dependent on the actuating direction. By way of example, actual value fluctuations, for example known load fluctuations which are dependent on the actuating angle, have a different effect on the trapping protection detection as a function of an actuating position of the backrest of a seat in a motor vehicle. Further parameters which influence the control loop are any external mechanical force F_{Mech} that is acting, any trapping force F_{Trapping}, any weight force F_{Person} of a person, the battery voltage U_{bat} for supplying a drive (which is not illustrated in FIG. 1) for the actuating device, and the temperature Temp of the drive and/or of the mechanical system of the actuating device.

The output signal from the regulator is a control signal which is evaluated in order to determine trapping. Various methods can be implemented for evaluation in the control apparatus, which evaluate the control signal either alternatively, successively or in parallel. By way of example, and not exhaustively, FIG. 1 illustrates the first variant of evaluation in the time domain. A second variant envisages evaluation in the image range. For this purpose, the control signal is transformed to the image range. In a third variant, the evaluation is carried out by means of a neural network. In contrast to a neural network, a closed set of output signals is supplied to a decision-making unit, when using classifiers in a fourth variant. The decision-making unit makes the decision as to whether trapping has occurred, on the basis of the output signals from at least one of the evaluating methods implemented.

If trapping has occurred, a set value preset which is associated with trapping is passed to the input of the control loop. If, for example, trapping has occurred, a set value preset which is associated with reversing of the actuating movement is output, and this results in current being passed through the drive in the opposite direction. Alternatively, the motor can also just be braked, by outputting the set value preset as the set value (0). During normal operation, when no trapping has been detected, no set value is preset, so that the set value can be read from a register, for example as a function of the position.

FIG. 2 shows a schematic illustration of the profile of the control signal over time. Provided that the control signal is within a permissible tolerance band, no trapping has occurred. Fluctuations in the control signal within the tolerance band are caused by low-frequency movement difficulties of the transmission or other mechanical parts.

If the control signal goes outside the tolerance band, as illustrated in FIG. 2, the control signal is evaluated to determine whether trapping has occurred. By way of example, the gradient or the frequency response of the control signal is evaluated for this purpose. As an alternative to the constant threshold values illustrated in FIG. 2, the tolerance band is preferably designed in such a manner that the time profile or position profile of the tolerance band is matched to learnt difficulties in movement of the mechanical system of the actuating device, to the weight of the user on the seat, and/or to the supply voltage.

List of reference symbols

| | |
|---|---|
| F_{Mech} | Friction force, difficulty in |
| | movement, external mechanical force |
| F_{Trapping} | Trapping force |
| F_{Person} | Weight force of the user |
| U_{bat} | Battery voltage |
| Temp | Temperature |

1. Method for controlling an actuating device in a motor vehicle, in particular a motor vehicle seat actuating device, in which a drive movement of a drive for the actuating device is stopped and/or the drive movement is reversed when trapping of an object or of a body part is determined, and in which the actuating movement, in particular the actuating speed, is regulated,
with a set variable, in particular a set speed, being predetermined,
with an actual variable, in particular an actual speed of the drive of the actuating device, being determined,
with the power supplied to the drive being varied by means of a control signal as a function of the set variable and of the actual variable, and
with the control signal or a signal which is correlated with the control signal being evaluated in order to determine trapping.

2. Method according to claim 1,
characterized in that, for evaluation purposes, the control signal or the rate of change of the control signal is compared with a threshold value.

3. Method according to claim 2,
characterized in that, for positions within the actuating movement, the threshold value is determined and stored by evaluation of the control signal or of the rate of change of the control signal as a function of the actuating position.

4. Method according to one of the preceding claims,
characterized in that, for evaluation purposes, the control signal is transformed, and the control signal, which has preferably been transformed to the frequency domain or to the scale range, is evaluated in order to determine trapping.

5. Method according to one of the preceding claims,
characterized in that a natural frequency or a plurality of natural frequencies of the closed-loop control system is or are distinguished from characteristic frequencies of trapping, in such a manner that the signal for the natural frequency and those components of the control signal which relate to trapping are different.

6. Method according to one of the preceding claims,
characterized in that the set speed is predetermined, in particular as a function of the actuating position and/or as a function of the actuating time, in such a manner that a characteristic of trapping is amplified in comparison to a different set speed.

7. Method according to one of the preceding claims,
characterized in that, in order to determine trapping, other measurement variables and/or control variables of the actuating device are evaluated, combined with the control signal, in addition to the evaluation of the control signal.

8. Method according to one of the preceding claims,
characterized in that the set speed is predetermined as a function of the actuating position and/or as a function of the actuating time, preferably as a function of the evaluation of the control signal or the rate of change of the control signal as a function of the actuating position.

9. Method according to one of the preceding claims,
characterized in that a sensor signal which is dependent on the actual speed is sampled in order to determine the actual speed.

10. Method according to one of the preceding claims,
characterized in that the actual speed is determined from a motor model and a motor characteristic variable, in particular the motor current.

11. Method according to one of the preceding claims,
characterized in that, in order to regulate the actuating speed, the control signal is converted to a motor control variable for power control, in particular to a mean motor voltage, preferably to a pulse-width-modulated signal.

12. Method according to claim 11,
characterized in that the actual speed is determined as a function of the motor control variable, in particular as a function of the pulse-width modulation.

13. Method according to one of the preceding claims,
characterized in that the set speed is set to the value zero in order to stop the drive.

14. Method according to one of the preceding claims,
characterized in that, in order to reverse the drive movement, the drive has current passed through it in an opposite direction, and the set speed is set at least temporarily to a maximum value.

15. Method for controlling an actuating device in a motor vehicle, in particular a motor vehicle seat actuating device, in which a drive movement of a drive for the actuating device is stopped and/or the drive movement is reversed when trapping of an object or of a body part is determined and in which an actuating torque is regulated,
with a set torque being predetermined,
with an actual torque of the drive for the actuating device being determined,
with the power supplied to the drive being varied by means of a control signal as a function of the set torque and of the actual torque, and
with the control signal being evaluated in order to determine trapping.

16. Control apparatus for an actuating device in a motor vehicle, in particular a motor vehicle seat actuating device, having a sensor for determination of an actual variable, in particular an actual speed, of a drive movement of a drive for the actuating device, and having a computation unit which is connected to the sensor and is designed and configured
to regulate the actuating speed of the drive movement as a function of the actual variable and of a predeterminable set variable, in particular of a predeterminable set speed, by means of a control signal, and
to stop or to reverse the drive movement as a function of an evaluation, associated with trapping, of the control signal,
and having a power driver for passing current through the drive as a function of the control signal.

17. Control apparatus according to claim 16,
characterized in that the computation unit is designed and configured to compare the control signal and/or the rate of change of the control signal with a threshold value, for evaluation.

18. Control apparatus according to claim 17,
characterized in that the computation unit is designed and configured to determine the threshold value for positions within the actuating movement by evaluation of the control signal or of the rate of change of the control signal as a function of the actuating position, and to store this in a memory, in particular in a non-volatile memory.

19. Control apparatus according to one of the preceding claims,
characterized in that the computation unit is designed and configured to transform the control signal for evaluation, and to evaluate the control signal, which has preferably been transformed to the frequency domain, in order to determine trapping.

20. Control apparatus according to one of the preceding claims,
characterized in that the computation unit is designed and configured to evaluate the signal for a natural frequency and the components of the control signal which relate to trapping separately if the natural frequency or a plurality of natural frequencies of the closed-loop control system differs or differ from characteristic frequencies for trapping.

21. Control apparatus according to one of the preceding claims,
characterized in that the computation unit is designed and configured to predetermine the set speed, in particular as a function of the actuating position and/or as a function of the actuating time, so that a characteristic of trapping is amplified in comparison to a different set speed.

22. Control apparatus according to one of the preceding claims,
characterized in that the computation unit is designed and configured to evaluate other measurement variables and/or control variables for the actuating device, combined with the control signal, in addition to the evaluation of the control signal, in order to determine trapping.

23. Control apparatus according to one of the preceding claims,
characterized in that the computation unit is designed and configured to predetermine the set variable as a function of the actuating position and/or as a function of the actuating time, preferably as a function of the evaluation (which is a function of the actuating position) of the control signal or of the rate of change of the control signal.

24. Control apparatus according to one of the preceding claims,
characterized in that, in order to determine the actual variable, the computation unit is designed to sample a sensor signal which is dependent on the actual variable.

25. Control apparatus according to one of the preceding claims,
characterized in that the computation unit is designed and configured to determine the actual variable from a motor model and a motor characteristic variable, in particular from the motor current.

26. Control apparatus according to one of the preceding claims,
characterized in that, in order to control the actuating speed, the computation unit is designed and configured to convert the control signal to a motor control variable for power control, in particular to a mean motor voltage, preferably to a pulse-width-modulated signal.

27. Control apparatus according to claim 11,
characterized in that the computation unit is designed and configured to determine the actual speed as a function of the motor control variable, in particular as a function of the pulse-width modulation.

28. Control apparatus according to one of the preceding claims,
characterized in that the computation unit is designed and configured to set the set variable to the value zero in order to stop the drive.

29. Control apparatus according to one of the preceding claims,
characterized in that the computation unit is connected to a power driver in order to pass current through the drive, and in that, in order to reverse the drive movement, the computation unit is designed and configured to drive the power driver to pass current through the drive in an opposite direction, and to set the set variable at least temporarily to a maximum value.

30. Digital memory medium, in particular a data storage medium, having open-loop control signals which can be read electronically and interact with a programmable computation unit in such a manner that a method according to one of claims 1 to 15 is carried out.

31. Computer program product having a program code, which is stored in a machine-legible storage medium, for carrying out the method according to one of claims 1 to 15 when the program product is run on a computation unit.

32. Computation program having a program code for carrying out the method according to one of claims 1 to 15 when the program product is run on a computation unit.
